(19) United States
(12) Patent Application Publication
(10) Pub. No.: US 2010/0157892 A1
(43) Pub. Date: Jun. 24, 2010

(54) MOBILITY SUPPORTING METHOD

(75) Inventors: Sung-Hyun YOON, Daejeon (KR); Soon-Seok Lee, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Deajeon (KR)

(21) Appl. No.: 12/505,795

(22) Filed: Jul. 20, 2009

(30) Foreign Application Priority Data
Dec. 22, 2008 (KR) 10-2008-0131614

(51) Int. Cl. H04W 40/00

(52) U.S. Cl. 370/328

(57) ABSTRACT

Provided is a mobility supporting method of a mobile router. The method includes generating an area identifier to identify an open shortest path first area; and transmitting routing information including the area identifier to an access router.

### CROSS-REFERENCE TO RELATED APPLICATIONS

This U.S. non-provisional patent application claims priority under 35 U.S.C. § 119 of Korean Patent Application No. 10-2008-0131614, filed on Dec. 22, 2008, the entire contents of which are hereby incorporated by reference.

### BACKGROUND OF THE INVENTION

The present invention disclosed herein relates to network system, and more particularly, to IP Network Mobility supporting method.

Network system includes routers for packet transmission. The router transmits data packets through the IP (Internet Protocol) layer. In order for the router to transmit data packets, routing protocol is used for its operations.

There are many kinds of routing protocol according to the purpose. Generally, the routing protocol used in an IP-based network system includes RIP (Routing Information Protocol), IGRP (Internet Gateway Routing Protocol), OSPF (Open Shortest Path First), EIGRP (Enhanced Internet Gateway Routing Protocol), IS-IS (Intermediate System to Intermediate System) routing protocol, and BGP (Border Gateway Protocol).

In addition, the IP-based network system generally uses MR (mobile router) for supporting mobility. A representative technique that supports mobility using the MR is NEMO (network mobility) technique suggested by IETF (Internet Engineering Task Force).

The NEMO requires legacy routing protocol as well as mobile IP. The mobile IP provides mobility to MR (mobile router) by expanding legacy IP. As the mobile IP is used, the NEMO additionally needs to include additional network components required for mobile IP system such as home agent. As such, if the mobile network system uses the mobile IP in the mobile router, the mobile network system additionally needs various system elements (e.g., home agent).

There exists a certain restriction that conventional methods for providing mobility to a network system are required to include an additional protocol or additional network components besides a routing protocol. Accordingly, a network system, which minimizes a change of a conventional network and also supports network mobility, is in great demand.

### SUMMARY OF THE INVENTION

The present invention provides a mobility supporting method for minimizing a network change in order to support mobility.

The present invention provides method for a mobility supporting of the network with using the mobile IP.

Embodiments of the present invention provide mobility supporting methods of a mobile router including: generating an area identifier to identify an open shortest path first area; and transmitting routing information including the area identifier to an access router.

In some embodiments, the generating of the area identifier includes generates an area identifier using an identifier of the mobile router itself.

In other embodiments, the open shortest path first area includes the mobile router and the access router.

In still other embodiments, the routing information is transmitted through a virtual link that passes through the access router.

In other embodiments of the present invention, mobility supporting methods of an access router include: once a mobile router is connected, receiving routing information from the mobile router, the routing information including an area identifier for identify an open shortest path first area; and transmitting the received routing information to a connected core router.

In some embodiments, the open shortest path first area includes an area including the mobile router and the access router.

In other embodiments, the routing information is transmitted through a virtual link, the virtual link passing sequentially through the access router and the core router to which the access router is connected.

In still other embodiments of the present invention, mobility supporting methods of an authentication server include: authenticating the mobile router through the access router when the mobile router is connected to an access router, wherein the authenticating step comprises generating an area identifier and, allocating the area identifier to the mobile router, the area identifier being used for identifying an open shortest path first area.

In some embodiments, the open shortest path first area includes the mobile router and the access router.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a view illustrating an example of a network system structure to which an MR is connected according to an embodiment;

FIG. 2 is a view illustrating an example of a network system structure to which an OSPF routing protocol is applied in a network system according to an embodiment; and

FIG. 3 is a flowchart illustrating and example of an operation of a mobility supporting network system according to an embodiment.

### DETAILED DESCRIPTION OF PREFERRED EMBODIMENTS

Embodiments will be described below in more detail with reference to the accompanying drawings. Only the necessary portion for understanding operations of the present invention will be described. It should be noted that detailed descriptions related to well-known functions or configurations will be ruled out in order not to unnecessarily obscure subject matters of the embodiments.

The embodiments are related to a network system and more particularly, to a mobility supporting method using OSPF (Open Shortest Path First) routing protocol.

The embodiments extend the OSPF routing protocol that routers uses in the network system to MR (mobile router). The MR generates an area identifier for identifying an OSPF area of the OSPF routing protocol as being connected to a network, and also network system components reflect the area identifier to their routing tables in order to provide mobility to the network system through the OSPF routing protocol.

Hereafter, it is assume that a network system is a system including a plurality of networks and components constituting the networks.

The network system uses MR for supporting mobility. The MR is a router that adds a radio network interface module to a router that connects IP (internet protocol)-based networks.

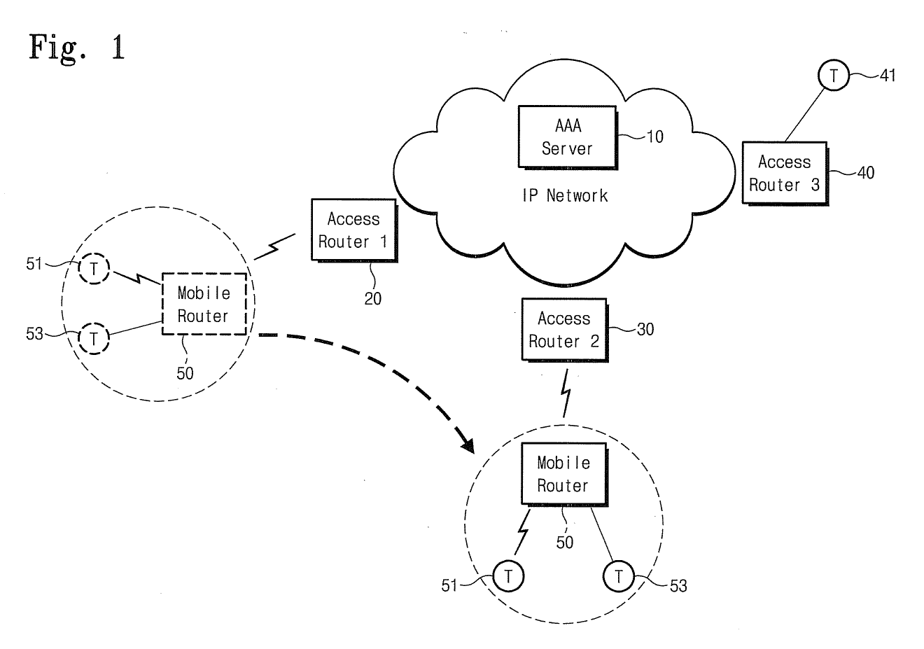

FIG. 1 is a view illustrating an example of a network system structure to which an MR is connected according to an embodiment.

Referring to FIG. 1, a network system includes AAA (Authentication, Authorization, and Accounting) server 10, an ARs (access routers) 20, 30, and 40, an MR 50, and terminals 41, 51, and 53.

The ARs 20, 30, and 40 are connected to an IP network, and the MR 50 is conventionally connected to the IP network through ARs 20, 30, and 40.

The MR 50 constitutes at least one network and also a mobile network because its network itself is mobile. Additionally, the terminals 51 and 53 are connected to the MR 50 through various forms such as wire and wireless and the MR 50 may include various interfaces to support communication with the terminals 51 and 53 connected through various forms.

The MR 50 performs an additional authentication procedure in order to connect with an IP network system. That is, the IP network system recognizes the MR 50 as one terminal until the MR 50 is recognized as a router. Thus, the IP network system performs an authentication procedure for the first network connection.

The MR 50 performs an authentication procedure through the AAA server 10 and the authenticating of the MR 50 is regarded as a network mobility service such that the lower level terminals 51 and 53 can receive service through the MR 50.

Additionally, the terminals 51 and 53 to be connected to the IP network system accomplish the authentication procedure through the AAA server 10. The authentication procedure includes terminal authentication and network authentication. During the authentication procedure, the AAA server 10 allocates an IP address for IP communication to a terminal that requires connection. Additionally, the AAA server 10 allocates authentication information in preparation for a case that re-authentication occurs later on and may recognize types of a terminal according to a level of an authentication procedure.

The MR 50 that performs the authentication procedure is connected to the IP network through the first AR 20. Additionally, the MR 50 is mobile in the IP network system. According to the movement of the MR 50, a service connection point may shifts from the first AR 20 to the second AR 30.

Additionally, the terminals 51 and 53 in the MR 50 recognize the MR 50 as a default router, i.e., a gateway, and maintain communication. The terminals 51 and 53 move together as the MR 50 moves, but each of the terminals 51 and 53 maintains communication without recognition about mobility.

Moreover, among routing protocols used in the IP-based network system, the OSPF routing protocol is a general-purpose routing protocol that does not belong to a specific vendor. The OSPF routing protocol is accepted as being more efficient compared to a conventional RIP (Routing Information Protocol).

In the present invention, mobility is provided to the MR 50 by expanding the OSPF routing protocol.

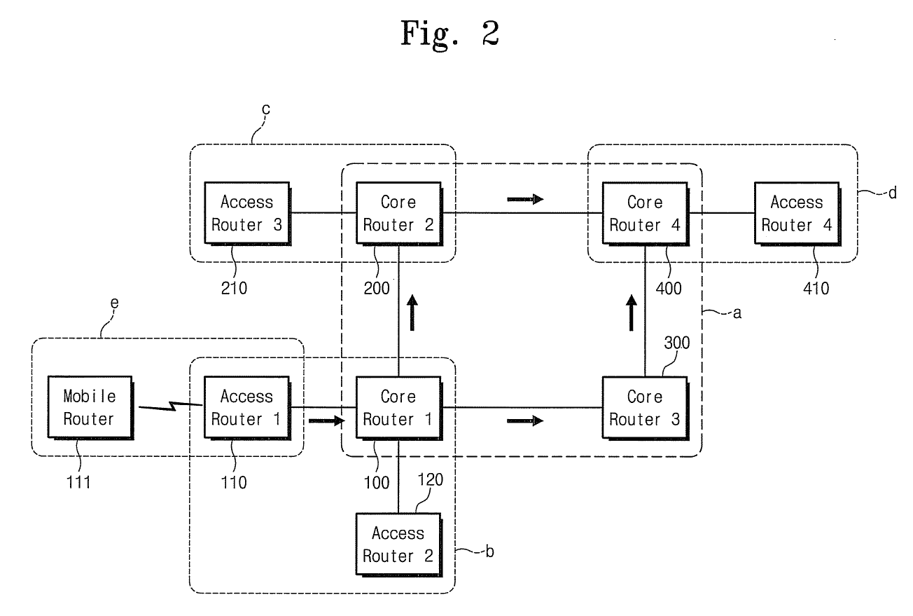

FIG. 2 is a view illustrating an example of a network system structure to which an OSPF routing protocol is applied in a network system according to an embodiment.

Referring to FIG. 2, the network system to which the OSPF routing protocol is applied includes a plurality CRs (core routers) 100, 200, 300, and 400, ARs 110, 120, 210, and 410, and an MR 111.

The MR 111 may be directly connected to CRs 100, 200, 300, and 400, but for convenience of description, it is assumed that the MR 111 is connected to the network system through one of the ARs 110, 120, 210, and 410.

The OSPF routing protocol is an IGP (Interior Gateway Protocol) that exchanges routing information between routers in an AS (Autonomous System) classified as one routing management area. Additionally, the OSPF routing protocol divides the AS into areas (i.e., OSPF areas) and performs layer 2 routing that connect the areas through a backbone network, i.e., a backbone area.

Each area has an original area ID (IDentifier) which is transmitted through a header of an OSPF packet. Especially, since the backbone area has a special area ID, it is distinguished from other areas.

Since the present invention uses the OSPF routing protocol, an entire network system is divided into a plurality of areas a, b, c, d, and e. The divided areas a, b, c, d, and e are called as OSPF areas because they are divided through the OSPF routing protocol.

The area a is an area where CRs 100, 200, 300, and 400 responsible for the center of the network system are included, and an area where the CRs 100, 200, 300, and 400 are included is called as a backbone area. The areas b, c, and d include the ARs 110, 120, 210, and 410 together with the CRs 100, 200, and 400. The area e is an area including the AR 110 and the MR 111 based on the connection of the MR 111.

The MR 111 generates an area ID about the area e where the MR 111 and the AR 110 are included once MR 111 is connected to the AR 110. The MR 111 generates an area ID by using its own ID. The MR 111 may generate an area ID through various methods.

For example, it is assumed that an area ID has the length of 32 bits. If the MR 111 has a 32 bit ID, it may use its own ID as an area ID. Additionally, if the MR 111 has an ID of more than 32 bits, it selects only the 32 bits from the entire ID (based on the MSB (Most Significant Bit) or the LSB (Least Significant Bit)) and may use it as an area ID. If the MR 111 has an ID of less than 32 bits, the MR 111 adds predetermined bits to have the length of 32 bits and uses it as an area ID.

The MR 111 uses a new area ID to support the OSPF routing protocol and is classified as one area in the OSPF routing protocol.

Additionally, the MR 111 is allocated with an area ID from the AAA server when an authentication procedure is performed using the AAA server.

The MR 111 uses an area ID to identify the area e of the MR 111 in the network system. The routing information including the area ID is transmitted to the CR 100 of the backbone area, i.e., the area a, through the AR 110.

However, since the area e is not directly connected to the area a (i.e., the backbone area) like the areas b, c, and d, routing information is transmitted to the backbone area through a virtual link. Likewise, since the routing information is delivered through a virtual link, a routing table of each router may be updated at a fast time. The routing information is transmitted through a virtual link passing through the MR 111, the second AR 110, and CR 100 sequentially.

This virtual link is created from the MR 111 to the CR 100 through the AR 110.

The AR 10 transmits the routing information including an area ID of the MR 111 and the CR 100 transmits the routing information to other CRs 200 and 300 in the area a. The CR 400 receives the routing information including an area ID of the MR 111 from the second CR 200 or the third CR 300.

Additionally, the third AR 210 receives routing information from the second CR 200, and the fourth AR 410 receives routing information from the fourth CR 400.

That is, the CR 110 propagates the routing information including an area ID of the MR 111 to other CRs 200, 300, and 400 in the area a.

The OSPF routing protocol of the present invention delivers routing information according to a change of a link state. As the MR 111 moves, the AR to which the MR 111 is connected is changed and routing information is transmitted into a corresponding AR.

If ARs and CRs are disconnected from the MR 111 when the MR 111 moves, the routing information of the corresponding MR 111 is removed.

Additionally, the MR 111 adds information about effective time to the routing information including an area ID. Additionally, an AR or CR receiving corresponding routing information may delete the routing information if the effective time of corresponding routing information is expired.

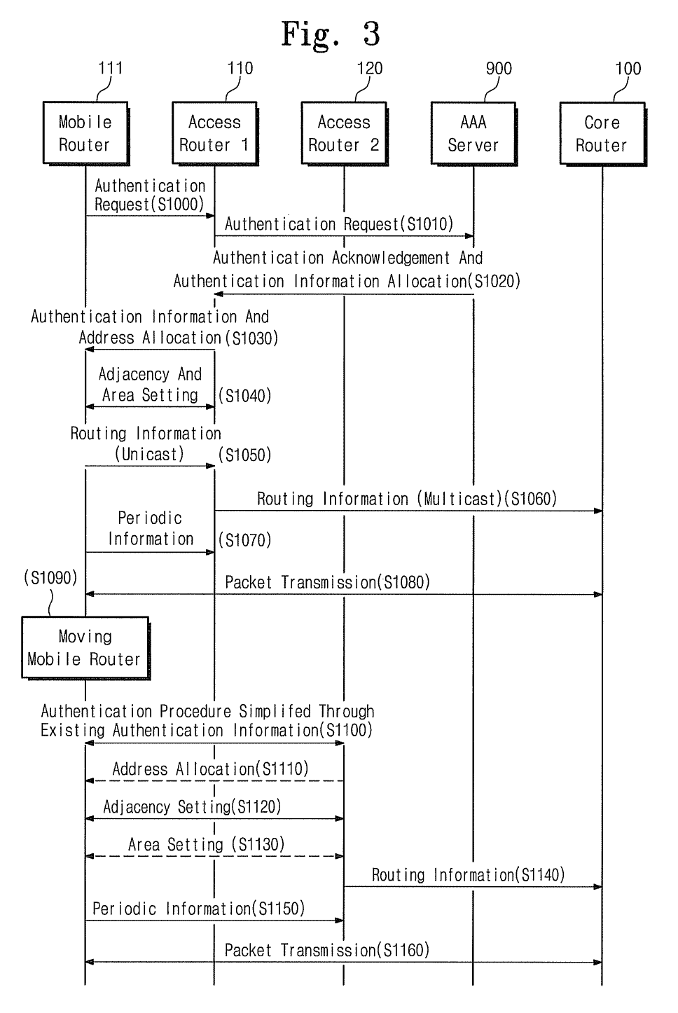

FIG. 3 is a flowchart illustrating an example of an operation of a mobility supporting network system according to an embodiment.

Referring to FIG. 3, an MR 111 begins an authentication procedure in order to connect with the network system. The MR 111 requests authentication to a network node, i.e., a first AR 110, according to an initial connection in operation S1000.

The first AR 110 requests authentication of the MR 111 to AAA server 900 in operation S1010.

In operation S1020, the AAA server 900 confirms whether authentication about the MR 111 is appropriate or not, and if not, the AAA server 900 approves the authentication and allocates authentication information necessary for instant re-authentication later on to transmit it to the first AR 110. The authentication information may be issued in a form of an authentication key and may be issued to the MR 111 and ARs (e.g., ARs 110 and 120). Therefore, if re-authentication is required later on during service, the authentication is possible without intervention of the AAA server 900.

The first AR 110 allocates an IP address to the MR 111 according to a network connection authentication of the MR 111. Additionally, the first AR 110 transmits the IP address allocated to the MR 111 and authentication information to the MR 111 in operation S1030.

When the MR 111 receives the IP address and authentication information, it creates an adjacency with the first AR 110 and sets an area in operation S1040. The MR 111 creates an adjacency with the first AR 110 by transmission a “Hello” message and sets up an area according to an adjacency formation. At this point, the MR 111 generates an area ID using its own information, for example, an original ID. Additionally, the MR 111 may be allocated with an area ID through the above authentication procedure.

The MR 111 transmits the routing information including an area ID to the first AR 110 in operation S1050. The area that the MR 111 and the first AR 110 create is not directly connected to a backbone area and thus is connected through a virtual link. Accordingly, the routing information is transmitted to the first AR 110 through a unicast form. The MR 111 transmits the routing information to the first AR 110 through LSD (a Link State Update) message.

Once the first AR 110 receives the routing information, it modifies its routing table and transmits the routing information to the connected CR 100 simultaneously in operation S1060. At this point, the routing information is transmitted through a multicast form.

The CR 100 simultaneously modifies its routing table and transmits the routing information received from other CRs in the backbone area in order to propagate a routing table to other CRs in the backbone area.

The MR 111 transmits information, for example, a “Hello” message, periodically in order to maintain a connection state in operation S1070.

Terminals connected to the MR 111 communicate with other terminals through the MR 111 and the MR 111 transmits a packet between the communicating terminals in operation S1080.

Next, once the MR 111 moves in operation S1090, it is disconnected from the first AR 110 that is currently connected thereto. The first AR 110 detects that the MR 111 moves or communication errors occur if the “Hello” message is not periodically received from the MR 111. Then, the first AR 110 removes the corresponding routing information and the adjacency.

The MR 111 can perform a simplified authentication procedure using the previously received authentication information in operation S1100. The MR 111 can perform a prompt re-authentication with the second AR 120.

The MR 111 acquires a new IP address through the new second AR 120 in operation S1110. At this point, if the second AR 120 uses the same network prefix as the first AR 110, operation S1110 can be omitted.

Next, the MR 111 sets up an adjacency with the new second AR 120 in operation S1120.

Additionally, once the MR 111 sets up the adjacency with the second AR 120, it generates an area ID to set up an area in operation S1130. If the second AR 110 has the same area ID as the first AR 110, operation S1130 can be omitted.

When the second AR 120 receives routing information, it transmits the routing information to the CR 100 in operation S1140. The MR 111 transmits the “Hello” message periodically to the second AR 120 in operation S1150.

Terminals connected to the MR 111 communicate with other terminals through the MR 111 and the MR 111 transmits a packet between communicating terminals in operation S1160.

The ARs or CRs, which receive the routing information including an area ID of the MR 111, update their routing tables using the routing information such that it is possible to identify the MR 111.

The network system of the present invention regards an MR as an AR (to which the MR is connected) and one OSPF area. For this, the MR uses an area ID that identifies an area where the MR itself is included. Therefore, the present invention uses an OSPF area concept in a routing domain where OSPF routing protocol is possible, thereby proving mobility to a network system.

Furthermore, the mobility in the network system of the present invention means that all terminals in a mobile network can be provided with a network connection service without recognition. Accordingly, the suggested MR of the present invention provides this network mobility in an IP level and seamlessly provides an internal connection service to each terminal even when an internet connection point is changed due to the terminal movement.

The suggested network system of the present invention uses one OSPF routing protocol among routing protocols that routers use, such that a change of an existing network is minimized and network mobility can be provided with low cost. Especially, the suggested network system of the present invention may be also applicable to a user who uses a network server in transportation means such as cars, trains, buses, ships, and airplanes.

According to the embodiment of the present invention, the suggested network system extends the OSPF routing protocol in MR to support mobility. As a result, a network change can be minimized. Furthermore, the network system does not require an additional mobile IP routing protocol and additional network components in behalf of MR.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A mobility supporting method of a mobile router, the method comprising:
generating an area identifier to identify an open shortest path first area; and
transmitting routing information including the area identifier to an access router.

2. The method of claim 1, wherein the generating of the area identifier comprises generates an area identifier using an identifier of the mobile router itself.

3. The method of claim 1, wherein the open shortest path first area comprises the mobile router and the access router.

4. The method of claim 1, wherein the routing information is transmitted through a virtual link that passes through the access router.

5. A mobility supporting method of an access router, the method comprising:
once a mobile router is connected, receiving routing information from the mobile router, the routing information including an area identifier for identify an open shortest path first area; and
transmitting the received routing information to a connected core router.

6. The method of claim 5, wherein the open shortest path first area comprises an area including the mobile router and the access router.

7. The method of claim 5, wherein the routing information is transmitted through a virtual link, the virtual link passing sequentially through the access router and the core router to which the access router is connected.

8. A mobility supporting method of an authentication server, the method comprising:
authenticating the mobile router through the access router when the mobile router is connected to an access router,
wherein the authenticating step comprises generating an area identifier and, allocating the area identifier to the mobile router, the area identifier being used for identifying an open shortest path first area.

9. The method of claim 8, wherein the open shortest path first area comprises the mobile router and the access router.
